(19) United States
(12) Patent Application Publication
(10) Pub. No.: US 2025/0356252 A1
(43) Pub. Date: Nov. 20, 2025

(54) FEDERATED LEARNING WITH CONCURRENT TRAINING OF MACHINE LEARNING MODELS

(71) Applicant: NVIDIA CORPORATION, Santa Clara, CA (US)

(72) Inventors: Minwoo Park, Saratoga, CA (US); Siyi Li, Shanghai (CN); Yichun Shen, Shanghai (CN); Adrian Ronald Goldenthal, Los Gatos, CA (US)

(21) Appl. No.: 18/737,005

(22) Filed: Jun. 7, 2024

Related U.S. Application Data
(63) Continuation of application No. PCT/CN2024/094048, filed on May 17, 2024.

(51) Int. Cl. G06N 20/00

(52) U.S. Cl. CPC G06N 20/00

(57) ABSTRACT

Systems and methods are disclosed that interleave federated learning of multiple machine learning models across multiple data centers or other networks, which may be located in distinct geographic locations, regions, or zones. This interleaving of the federated learning of multiple machine learning models may comprise designating which machine learning models are to be trained at which data centers (or other location types), and when to trigger rounds of concurrent training in different data centers. For example, the beginning of a first round of training of corresponding machine learning model may be triggered at each corresponding data center, a determination may be made that the first round of training has been completed, model update data may be rotated to the next scheduled data centers, and the next schedule machine learning models may be loaded and trained.

### CROSS-REFERENCE TO RELATED APPLICATIONS

This application is a continuation of, and claims priority to, International Application No. PCT/CN2024/094048 filed May 17, 2024, the contents of which are incorporated by reference.

### BACKGROUND

Federated learning is a machine learning paradigm that allows for model training across decentralized and distributed devices or servers while keeping the raw data localized. In a federated learning setup, a machine learning model may be trained collaboratively on individual devices or servers without the need to generate a centralized repository of training data. A typical federated learning process involves a series of iterative updates where each device computes a model update based on its local data and transmits some representation of the update to a central server. These updates may take the form of data such as updated model weights which represent learned parameters of a machine learning model, or gradients which represent the partial derivatives of the loss functions with respect to the weights. The central server aggregates these updates to refine a global version of the model. This approach is particularly valuable in privacy-sensitive scenarios, as it allows machine learning models to be trained without exposing raw data to a central authority. Federated Learning has applications in various domains, including via mobile device, edge computing, and Internet of Things (IoT) environments, where data privacy and security are often of paramount concern. As such, federated learning can enable collaborative model training across a network of devices, fostering privacy preservation while still achieving the benefits of centralized model improvements. In many cases, federated learning can facilitate training machine learning models across distinct locations with distinct training data.

However, conventional federated learning techniques have a variety of drawbacks. For example, some existing techniques train models using allocated resources such as Graphical Processing Units (GPUs), central processing units (CPUs), deep learning accelerators (DLAs), other accelerator types, and/or other processing device types. However, between training iterations in a given region, these allocated resources often remain idle, which decreases the efficient use of valuable resources. Some further solutions may include renting out or allocating the GPUs or other compute resources for other projects while training is not being conducted. But these rented GPUs and other resources will have to be returned to the state required for machine learning training once returned, which requires substantial computational effort and results in latency between training iterations. More generally, conventional techniques underutilize computational resources and lead to inefficient resource utilization. As such, there is a need for a more efficient system for conducting federated learning.

### SUMMARY

Embodiments of the present disclosure relate to federated learning with concurrent training of machine learning models. Systems and methods are disclosed that interleave federated learning of multiple machine learning models across multiple data centers or other networks, which may be located in distinct geographic regions or zones. This interleaving of the federated learning of multiple machine learning models may comprise determining which machine learning models are to be trained at which data centers, and orchestrating when to trigger rounds of training.

In contrast to conventional systems, instead of training a single machine learning model and then rotating the training of the single model across multiple data centers as in standard federated learning, interleaving federated learning across multiple data centers may facilitate each data center and its associated resources remaining active while multiple machine learning models are being trained across multiple data centers concurrently. This may be accomplished through the use of a concurrent training scheduler which orchestrates training the multiple machine learning models across the multiple data centers.

The concurrent training scheduler may implement a training and/or rotation schedule designated based on data center, machine learning model, and/or training information such as planned resources on which to conduct training (e.g., number of GPUs), amount and type of training data, model load speed, upload download time of model data; machine learning model topologies, training algorithms, number of steps per round of training, time required for each step for various machine models, and/or others. This schedule may designate the triggering of rounds of training across multiple data centers, the triggering of the rotation of model update data, and/or triggering of the unloading and loading of machine learning models across data centers. For example, a first machine learning model, a second machine learning model, and a third machine learning model may begin training at a first, second, and third data center. Upon completion of a first round of training, the model update data for each machine learning model may be transmitted to the next data center at which the corresponding machine learning model is to be trained. The machine learning models that completed their first round of training may be unloaded from their corresponding data centers and loaded at the next data center at which they are to be trained. Embodiments such as these provide for substantially constant use of limited resources across a number of data centers with less down time than prior techniques, and the concurrent training of more than one machine learning model, which is a more efficient use of computational (e.g., data center) resources than alternative or prior techniques.

### BRIEF DESCRIPTION OF THE DRAWINGS

The present systems and methods for federated learning with concurrent training of machine learning models are described in detail below with reference to the attached drawing figures, wherein:

FIG. 1 is a block diagram of an example federated learning environment, in accordance with some embodiments of the present disclosure;

FIG. 2 illustrates an example model rotation, in accordance with some embodiments of the present disclosure;

FIG. 3 is a flow diagram illustrating a method of triggering simultaneous federated learning, in accordance with some embodiments of the disclosure;

FIG. 4 is a flow diagram illustrating a method of rotating model update data across regions, in accordance with some embodiments of the disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed relating to federated learning with concurrent training of machine learning models. In some embodiments, federated learning of multiple machine learning models may be interleaved across multiple data centers or other networks, which may be located in distinct geographic regions or zones. For example, three different models may be simultaneously trained in three different regions, and when a designated amount of training has concluded in each region, the model update data may be rotated to another region at which the associated model is to be trained next, and so on. This rotation schedule facilitates more efficient use of GPUs and other resources than prior or alternative techniques while reducing idling or the need to release allocated resources while machine learning models are trained in other regions.

For example, when conducting federated learning, one data center may be located in a first region (e.g., China) and another data center may be located in a second region (e.g., the United States). Each data center (or other set of one or more networked devices) may comprise any number of processing units such as Graphical Processing Units (GPUs) on which the various machine learning models may be trained on training data that is distinct to each data center and/or geographic region. Once the machine learning models have completed a predetermined number of training steps, model update data (e.g., weights and/or gradients) for each machine learning model may be transferred from one data center to another (e.g., through a centralized component such as a dedicated federated learning server and/or a model update orchestrator). Generally, a concurrent training scheduler may use a designation of the different models to be trained, training locations, amount of training (e.g., number of training steps), training algorithms, and/or other features to orchestrate rotation and training. In some embodiments, the training of the machine learning models may begin or be triggered at each distinct data center substantially simultaneously. Once a designated amount of training (e.g., steps, epochs, etc.) for each machine learning model is complete, model update data (e.g., weights, gradients) may be rotated from each data center (e.g., via the federated learning server and/or the model update orchestrator), to the next data center scheduled for training. Additionally or alternatively, after the designated amount of training for each machine learning model is completed at each data center, each machine learning model may be unloaded from the data center at which it completed training and loaded onto allocated resources (e.g., processing units such as GPUs) of the next data center in the rotation (where its corresponding model update data was transferred). This process may be repeated any number of times to train any number of machine learning models at any number of data centers.

By way of non-limiting example, federated learning may be conducted for three machine learning models across three data centers located in three distinct geographic locations, each of which may be connected to the federated learning server. Prior to beginning the federated learning across the three locations, the concurrent training scheduler may transmit to each data center the times or checkpoints at which the model update data will be transferred from one location to another. For example, Model A may be trained at location 1 using location 1's training data for 200 steps, while at the same time (or for at least partially overlapping windows of time), Model B may be trained at location 2 with location 2's training data for 200 (or some other number of) steps, and Model C may be trained at location 3 with location 3's training data for 200 (or some other number of) steps. The concurrent training scheduler may orchestrate the time at which the model update data for each of Model A, Model B, and Model C may be transferred to the next location. For example, once Model A, B, and C are finished, the Model A update data may be transferred to location 2, the Model B update data may be transferred to location 3, and the Model C update data may be transferred to location 1. Taking an example in which the model update data represents weights and/or gradients, an instance of Model A in location 2 may be updated using the weights and/or gradients from location 1 and trained in location 2 using the training data stored at location 2. An instance of Model B in location 3 may be updated using the weights and/or gradients from location 2 and trained in location 3 using the training data stored at location 3. An instance of Model C in location 1 may be updated using the weights and/or gradients from location 3 and trained in location 1 using the training data stored at location 1. Once the predetermined amount of training is executed (e.g., a designated number of steps are run), the model update data may be transferred to the next location in the rotation. This transfer and learning may be done for any number of rounds and, each transfer of model update data and instruction to load or unload a model may be made through the federated learning server. As such, the federated learning scheduler may facilitate and coordinate the concurrent use of GPUs and other resources which would otherwise remain idle.

As such, the techniques described herein may be used to conduct federated learning with concurrent training of machine learning models. By interleaving federated learning of different machine learning models and rotating the models being trained in a given region during successive rounds of training, allocated training resources (e.g., allocated compute units such as GPUs in a distributed computing environment) need not be released or idle like in conventional techniques. Avoiding the release of allocated resources can avoid the need to wait in lengthy queues for the next round of training (which can take hours or even days depending on demand), and can reduce the wear and tear that would otherwise occur in releasing and reallocating resources (e.g., due to power cycling, data transfers, memory wear, corresponding temperature fluctuations, etc.). As such, the present techniques improve resource utilization, resulting in more efficient resource allocations than prior or alternative techniques, improved overall system performance, and training speeds.

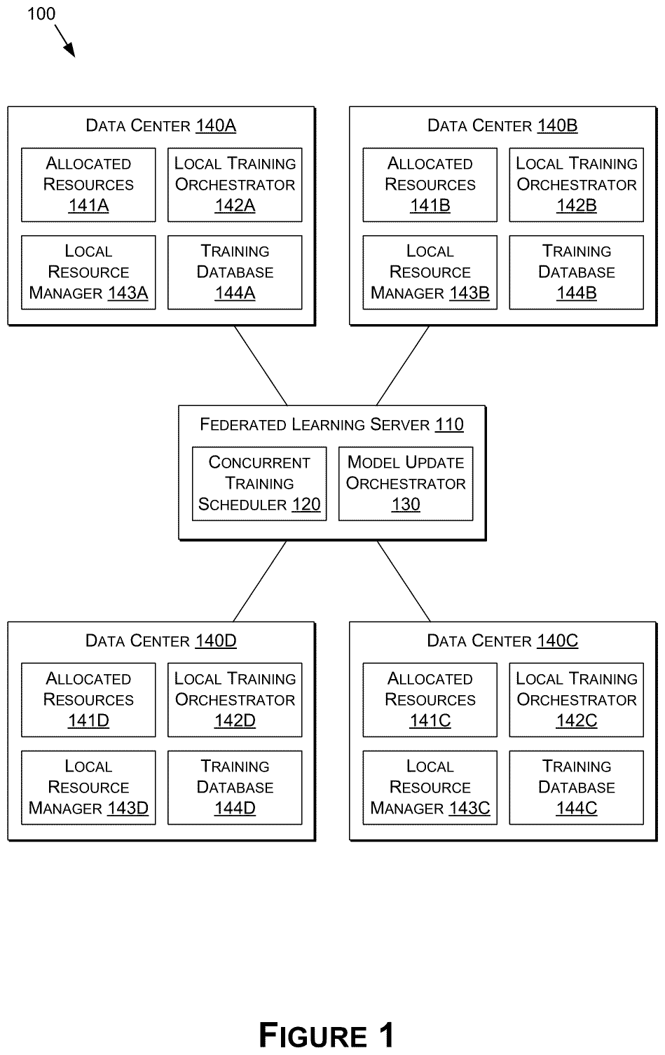

With reference to FIG. 1, FIG. 1 is an example federated learning environment 100 with a communicatively connected server, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

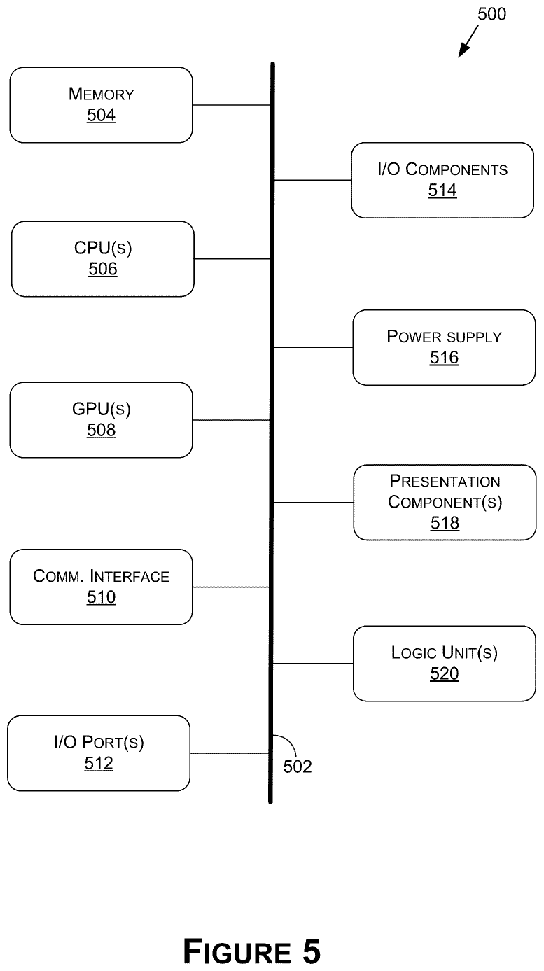

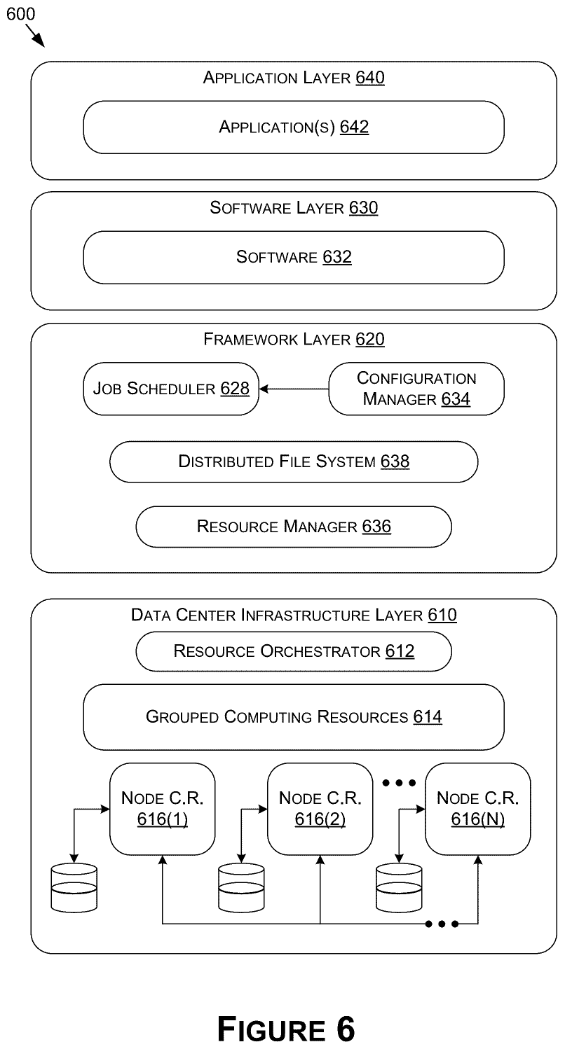

The federated learning environment 100 of FIG. 1 may comprise a number of nodes (which, as with other components described herein, may include similar components, features, and/or functionality to the example computing device 500 of FIG. 5) on which machine learning may be conducted. Any form of machine learning may be conducted in this federated learning environment 100, such as linear regression, support vector machines, random forest, deep neural networks, or k-means clustering, by way of example. The federated learning environment 100 may be hosted across any number of data centers (e.g., the data center 600 of FIG. 6), and the illustrated portion of federated learning environment 100 may represent some portion (e.g., a cluster of nodes) of a larger federated learning environment.

A federated learning server 110 may interleave loading, training, and unloading of any number of machine learning models across any number of data centers, such as data centers 140A-140D. As such, the federated learning server 110 may coordinate simultaneous rounds of federated learning of the machine learning models in different data centers and may rotate model update data from data center to data center in successive rounds of training. In the rotation, each machine learning model may be unloaded from the data center at which its current round of training was completed and (e.g., a corresponding local copy in the next data center) may be loaded in the next data center where the next round of training is scheduled (e.g., and where its model update data was or will be transmitted). The simultaneous rounds of federated learning may be conducted any number of times to train the machine learning models.

The federated learning environment 100 may include a federated learning server 110 that is connected to at least one data center such as data center 140A via one or more networks. The federated learning server 110 may be comprised of any number of components, but may at least include a concurrent training scheduler 120 and a model update orchestrator 130. The federated learning server 110 may be hosted at a geographical location which is distinct from some or all of the data centers associated with the federated learning environment 100. For example, if a first data center is located in China and a second data center is located in the United States, the federated learning server 110 may be hosted in Japan. The federated learning server 110 may act as the middleman in communications between the data centers, facilitating communication of data from one data center to another. In embodiments, the data centers do not communicate directly with one another. Instead, a data center may transmit communications and data to the federated learning server 110 which may transmit communications and data to a different data center. This may be for a variety of reasons, which may include geographic data restrictions or geographic communication restrictions for the data centers. As such, the data centers may never need to communicate directly and may instead transmit information through the federated learning server 110, facilitating transmission of data which is not geographically restricted.

In some embodiments, the federated learning server 110 may comprise a concurrent training scheduler 120. The concurrent training scheduler 120 may orchestrate a schedule for training any number of machine learning models concurrently across any number of data centers, and/or may transmit a schedule of training or instructions to begin a round of training to any number of data centers (e.g., load a schedule model, weights, training algorithm, etc.). The concurrent training scheduler 120 may wait until receiving indications that training has been completed at any number of scheduled data centers before triggering a rotation and subsequent round of training. By way of further non-limiting example, a first training round may comprise a first machine learning model to be initially trained at data center 140A, a second machine learning model to be initially trained at data center 140B, a third machine learning model to be initially trained at data center 140C, and a fourth machine learning model to be initially trained at data center 140D.

The concurrent training scheduler 120 may use a designation of the different models to be trained, topology of the models, training locations, amount of training (e.g., number of training steps), training algorithms, and/or other features to orchestrate rotation and training of a plurality of machine learning models. In addition or alternatively, the concurrent training scheduler 120 may use a designation of the data center resources with which to conduct training (e.g., number of GPUs, servers, virtual machines, etc.), amount and type of training data, model load speed, and/or upload download time of model data to orchestrate rotation and training. The concurrent training scheduler 120 may use these sets of data to orchestrate a schedule for the concurrent training of multiple machine learning models including at least the initiation of training and/or when to transfer model update data across data centers for any number of models across any number of data centers. The simultaneous training provided by the concurrent training scheduler 120 may ensure that the allocated resources 141A-141D of each data center are used more efficiently than prior or alternative techniques and reduces the amount of allocated resources 141A-141D that are kept idle.

In embodiments, the allocated resources 141A-141D may comprise processing resources (e.g., processing threads within a processor, individual cores of a multi-core chip, servers, virtual machines), memory or storage resources (e.g., random access memory (RAM), hard drives, solid state drives (SSDs), distributed file systems, disk input/output (I/O), memory bandwidth), networking resources (e.g., network bandwidth, network I/O). The allocated resources 141A-141D may comprise any computing resources to facilitate training a machine learning model for any number of training steps and/or rotations.

The model update orchestrator 130 may facilitate the transfer and rotation of model update data across any number of data centers such as data center 140A, data center 140B, data center 140C, and data center 140D (e.g., without the need for the data centers to directly communicate with one another). In embodiments, the model update orchestrator 130 may transmit instructions to the data centers to unload models which were trained and/or to load models which are next to be trained in the schedule. By way of example, in a first rotation, a respective local training orchestrator 142A-142D in each data center 140A-140D may trigger transmission of their respective model update data to the federated learning server 110 and/or the model update orchestrator 130, and the model update orchestrator 130 may then cause the transmission of each set of model update data to the corresponding subsequent data center. Additionally or alternatively, the model update orchestrator 130 may transmit instructions to unload and load corresponding machine learning models to the subsequent data center. By way of non-limiting example, the model update orchestrator 130 may transmit the model update data from data center 140A to data center 140B, and the model update data from data center 140B to data center 140C, the model update data from data center 140C to data center 140D, and the model update data from data center 140D to data center 140A. This may be accomplished by the model update orchestrator 130 without requiring any of the data centers to directly communicate with one another. The model update orchestrator 130 may transmit instructions to the data centers instructing which model is to be unloaded and loaded at which data center before or after rounds of training.

Moving to the data centers 140A-140D, each data center may be located at a distinct geographic location at which machine learning models are trained. By way of non-limiting example, data center 140A may be located in the United States and data center 140B may be located in China. Each of these data centers may be associated with data restrictions which restricts the types of information that may be stored in each respective training database 144A-144D or what types of information may be transferred to and from the location. In embodiments, the federated learning environment 100 may transfer model update data such as parameter, weights, biases, and/or gradients to other potentially data restricted data centers (e.g., through the federated learning server 110 through the use of the model update orchestrator 130) without the need to transfer restricted data or for the data centers to directly connect to each other. Data centers such as those represented by data centers 140A-140D may be comprised of any number of components such as allocated resources 141A, a local training orchestrator 142A, a local resource manager 143A and a training database 144A. Each data center may consist of each of their own components as illustrated in FIG. 1. Therefore, the discussion of the components associated with data center 140A may also describe the components of data centers 140B-D. In embodiments, the allocated resources 141A-141D may be resources used in the training of machine learning models such as processing resources, memory or storage resources, or networking resources. In additional or alternative embodiments, the local training orchestrators 142A-142D which manage the resources of each data center, may load and unload machine learning models and/or training data, and/or receive instructions from the concurrent training scheduler 120 and model update orchestrator 130 to load or unload models and/or begin training. The local resource managers 143A-143D may allocate, hold, and/or reserve resources for a requested task (e.g., training machine learning models). The training databases 144A-144D may store training data and/or machine learning model topologies.

The training database 144A may be configured to store training data, the topology of at least one machine learning model, and/or model update data such as weights and/or gradients obtained after rounds of training. The training database 144A may store training data with geographic restrictions disallowing them from being transferred to a data center located at a different geographic location. In embodiments, the local training orchestrator 142A may retrieve training data or model data from the training database 144A and/or load them to the allocated resources 141A (e.g., GPUs) associated with the local data center 140A. As such, local training orchestrator 142A may facilitate the transmission of geographically sensitive training data to the correct training resources while restricting communication between data centers.

Each of data centers 140A-140D may include a local resource manager that is responsible for provisioning resources. Local resource manager 143D, for example, may provision and manage an allocation of computing resources, such as processing resources (e.g., processors, accelerators, processing units, GPUs, CPUs, DLAs, etc.), memory resources (e.g., random access memory (RAM), hard drives, solid state drives (SSDs), distributed file systems, disk input/output (I/O), memory bandwidth), and/or networking resources (e.g., network bandwidth, network I/O) to support services such as the training of machine learning models. Local resource manager 143D may provision resources to ensure that data center 140A have the necessary capabilities to execute tasks efficiently. Local resource manager 143D may allocate resources such as containers, pods, and/or other resources that support allocated containers or pods (e.g., processing resources, memory or storage resources, networking resources).

When a request from an authenticated user or account to allocate resources arrives, a gateway, authentication service, or some other component, for example the local training orchestrator 142D, may inform the local resource manager 143D, which may allocate one or more services to support that request (e.g., by allocating a server, virtual machine, container, pod, and/or other supporting resources to the user or account). Generally, the local resource manager 143D may deploy and/or manage any of the services (e.g., a microservice of a service provisioning, deployment, scaling, or management application; and/or some other microservice of the data center 140A that facilitates execution of machine learning model training) in one or more corresponding containers and/or pods. This is meant simply as an example, and data center 140A may additionally or alternatively host other types of cloud services and/or applications. The local training orchestrator 142D may be loaded to or connected with the resources allocated by local resource manager 143D. The local resource manager 143D may maintain these resources for any number of rotations or training rounds without releasing the resources (e.g., until being notified by the local training orchestrator 142D that training is completed).

As discussed above, the allocated resources 141A of data centers 140A may be resources such as different numbers and types of GPUs, network bandwidth, CPUs and/or other computer resources used in the management and training of machine learning models, which all may be managed by a local training orchestrator such as local training orchestrator 142A. The local training orchestrator 142A may provision local resources, such as allocated resources 141A, to ensure the components of the data center have the necessary capabilities to execute tasks efficiently. For example, the local training orchestrator 142A may break down larger jobs into tasks, select and allocate processing resources for each task. Generally, the local training orchestrator 142A may deploy and/or manage any aspect of the local machine learning model training. For example, the local training orchestrator 142A may determine what allocated resources 141A are to be used in training, and what training data is to be loaded from the training database 144A to which GPUs (and/or other processors) in order to implement the training of the machine learning model at data center 140A. The local training orchestrator 142A may unload and load machine learning models to GPUs of the data center 140A prior to or after machine learning model training is to commence. In embodiments, when instructions are received from the model update orchestrator 130, the local training orchestrator 142A may load one or more corresponding models, for example from the training database 144A, onto allocated resources such as a server or GPU that provides an API endpoint for inference. In embodiments, the local training orchestrator 142A may determine whether an applicable model is currently being served, and if not, to load it and any associated API from a model registry such as the training database 144A. The local training orchestrator 142A may load and unload training data to the GPUs of data center 140A prior to or after machine learning model training is to commence. In embodiments, the local training orchestrator 142A may receive the model update data transmitted from another data center through the federated learning server 110 generated from a round of training at the other data center. The local training orchestrator 142A may load the model update data to the GPUs of data center 140A prior to or after machine learning model training is to commence.

The local training orchestrator 142A may determine when to trigger the loading and unloading of various machine learning models, when to load model update data, and/or when to load training data from the training database 144A to the allocated resources 141A (e.g., GPUs) of data center 140A. Local training orchestrator 142A may collect and transmit model update data. In embodiments, the local training orchestrator 142A may transmit data such as model update data to the federated learning server 110. The local training orchestrator 142A may communicate to the federated learning server 110 a notification that a round of training has commenced at data center 140A and/or that a round of training has been completed at data center 140A. The local training orchestrator 142A may receive an indication that the local machine learning model has completed a round of training and/or receive or collect the model update data for the round of training. Each of local training orchestrators 142A-142D may transmit data to and/or receive data from the federated learning server 110 such as the status of the machine learning model training at each of data centers 140A-140D, and/or model update data from the data centers such as data centers 140A-140D.

In embodiments, the local training orchestrator 142A may receive instructions from the concurrent training scheduler 120 instructing the local training orchestrator 142A to commence a round of training (e.g., for a predetermined number of steps). The local training orchestrator 142A may receive instructions from the model update orchestrator 130 instructing which model to unload and which model to load to the data center 140A and/or receive the model update data for the next round of training for the data center 140A. Upon completion of a round of training, the local training orchestrator 142A may transmit an indication that the first round of training has completed to the concurrent training scheduler 120 and/or may transmit model update data to the model update orchestrator 130. In initial or subsequent rounds of training, local training orchestrator 142B may receive the model update data transmitted to the model update orchestrator 130 from local training orchestrator 142A and/or receive instructions to begin a first or subsequent round of training from the concurrent training scheduler 120.

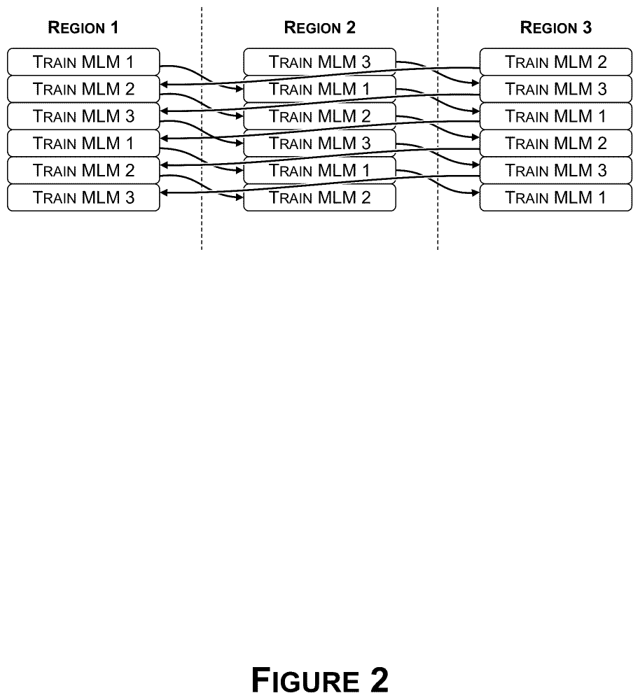

With reference to FIG. 2, FIG. 2 is an example model rotation, in accordance with some embodiments of the present disclosure. In embodiments, any number of machine learning models may be trained and their associated model update data rotated across any number of regions and/or data centers in an environment such as the federated learning environment 100. FIG. 2 illustrates a non-limiting example of a rotation of three machine learning models (MLMs), MLM 1, MLM 2, and MLM 3 across three distinct regions, Region 1, Region 2, and Region 3. In embodiments, Region 1, Region 2, and Region 3 may be data centers such as data centers 140A-140D, and/or may be geographically distinct. Additionally or alternatively, each region may be associated with distinct training databases such as training databases 144A-144D each of which may store geographically distinct data. Said data may be geographically restricted such that the training data may not be transferred from region to region.

A schedule of model rotations may be orchestrated by, for example, the concurrent training scheduler 120 discussed in relation to FIG. 1. The schedule may designate beginning training of MLM 1 at Region 1, beginning training of MLM 2 at Region 2, and beginning training of MLM 3 at Region 3. The schedule may additionally or alternatively include which region the model update data for the three MLMs are to be transferred to, and which MLM is to be loaded to which region after a first round of training and/or subsequent rounds of training. Each of MLM 1, MLM 2, and MLM 3 may be trained for a predetermined number of steps for each training cycle. At the end of each cycle, the model update data associated with each MLM may be transmitted from each region, through the federated learning server 110 to the next corresponding region. Further, at the end of each cycle, the next MLM may be loaded at the next corresponding region such that the next model may be trained at the next region with the model update data received from the previous region.

In embodiments, each of MLM1, MLM 2, and MLM 3 may be the same or different types of models, may be trained using the same or different training algorithms, and/or may be trained for the same or different numbers of steps in each cycle. In some scenarios, the training schedule may be designated to approximate roughly equivalent durations of time to train each model in any given round so any given round of training finishes at approximately the same time in the different data centers. By way of non-limiting example, MLM 1 may be trained for 10 steps or iterations, MLM 2 trained for 15 steps or iterations, and MLM 3 trained for 30 steps or iterations. When training is to be initiated, the concurrent training scheduler 120 may transmit instructions to the local training orchestrators 142A-142D of each data center to initiate training. The local resource managers 143A-143D may allocate the resources needed to initiate training and/or may hold the allocate resources for rounds of training without releasing the resources. Each local training orchestrator 142A-142D may load a designated model, load baseline weights (whether initialized as 0s, pre-trained, or otherwise), training algorithm and/or training instructions (e.g., number of iterations/epochs, location of training data) onto the allocated resources. The local training orchestrators may receive instructions of when to initiate training and/or when to transmit model update data to the model update orchestrator 130.

Once the first round of training is completed, the concurrent training scheduler 120 may be notified, for example, by the local training orchestrators 142A-142D, that the first round of training has been completed. In embodiments, the concurrent training scheduler 120 may receive notifications from each of the local training orchestrators 142A-142D (e.g., in any order). In additional or alternative embodiments, the concurrent training scheduler 120 may only receive notification from, for example, Region 1 and Region 2 without receiving notification that the first round of training has been completed at Region 3. In said embodiments, the concurrent training scheduler 120 may wait to transmit instructions to begin the second round of training until notification that the first round of training has been completed at all three regions, including Region 3. Additionally or alternatively, the local training orchestrators 142A-142D may transmit model update date generated from the first round of training to the model update orchestrator.

A second round of training may be initiated at subsequent regions upon the completion of the first round of training. For example, once notification of the completion of the first round of training has been received from each of Region 1, Region 2, and Region 3, a second round of federated learning may be triggered. The second round of federated learning may comprise transmitting, for example, using the model update orchestrator 130, the model update data generated from the first round of training for each of MLM1, MLM 2, and MLM 3 to the next region at which the MLMs are to be trained. The second round of federated learning may additionally or alternatively comprise transmitting instructions, for example, using the model update orchestrator 130, to each region to unload the current MLM which has completed the first round of training and transmit instructions to load the next MLM model to be trained. For example, as illustrated in FIG. 2, the model update data generated from the first round of training for MLM 1 may be transmitted from Region 1, through the federated learning server 110, to Region 2 and MLM 3 may be unloaded from a data center associated with Region 2, and MLM 2 may be loaded to the data center associated with Region 2.

Additionally or alternatively, the model update data generated from the first round of training for MLM 3 may be transmitted from Region 2 to Region 3 and MLM 2 may be unloaded from a data center associated with Region 3 and MLM 3 may be loaded to the data center associated with Region 3. Finally, for the first rotation after the first round of training, the model update data generated from the first round of training for MLM 2 may be transmitted from Region 3 to Region 1 and MLM 1 may be unloaded from a data center associated with Region 1 and MLM 2 may be loaded to the data center associated with Region 1. The rotation of model update data and the loading and unloading of models may be done any number of times for any number of rounds or epochs of training. Upon receiving notification of the completion of a final round of training, the model update orchestrator 130 may transmit instructions to the local training orchestrators 142A-142D to unload the current machine learning model and/or transmit instructions for the local training orchestrators 142A-142D to trigger the local resource managers 143A-143D to release the resources allocated and/or held by the local resource managers 143A-143D.

The loading and unloading of each MLM at each data center may be accomplished or coordinated by a local training orchestrator associated with each region, such as the local training orchestrator 142A-142D illustrated in FIG. 1. The local training orchestrator of each region may receive a transmission from the model update orchestrator 130 which may include instructions to load and unload particular models or may transmit the model update data for the next round of training. Additionally or alternatively, the local training orchestrator of each region may determine what resources need to be allocated for each subsequent model and what training data is to be used from the local training database, examples illustrated in FIG. 1 as the training database 144A-144D. The local training orchestrator of each region may determine the number of GPUs to be used and what training data is to be loaded to which GPU for each round of training. As described above, each region's database may store data which is unique to each region. The data stored at each region may be geographically restricted. For example, Region 1 may be located in China and Region 2 may be located in the United States. There may be restrictions that make it such that the data stored in the database of Region 1 cannot be transferred or disseminated to Region 2, or may be restricted such that the data stored in the database of Region 1 may not be transferred or disseminated to any other region. A similar situation may take place where first training is performed in a cloud using general, public data and the second training is performed locally at an entity using private data—e.g., medical data, personal data, etc.—that is not to be distributed or used outside of the entity's location.

As such, in embodiments, the only data transferred from region to region in the illustrated rotations is the model update data generated during each round of training. Generally, this model update data will not be geographically restricted. As such, the model update data such as weights and gradients generated by each round of training may be transmitted to further regions, for example, using the model update orchestrator 130 through the federated learning server 110. This rotation of model update data and the loading and unloading of models across multiple regions allows for multiple machine learning models to be trained concurrently across any number of regions without the need to transmit training data from region to region. This makes for more efficient use of the resources of multiple regions then prior or alternative techniques without the need for valuable resources to remain dormant while other regions conduct training.

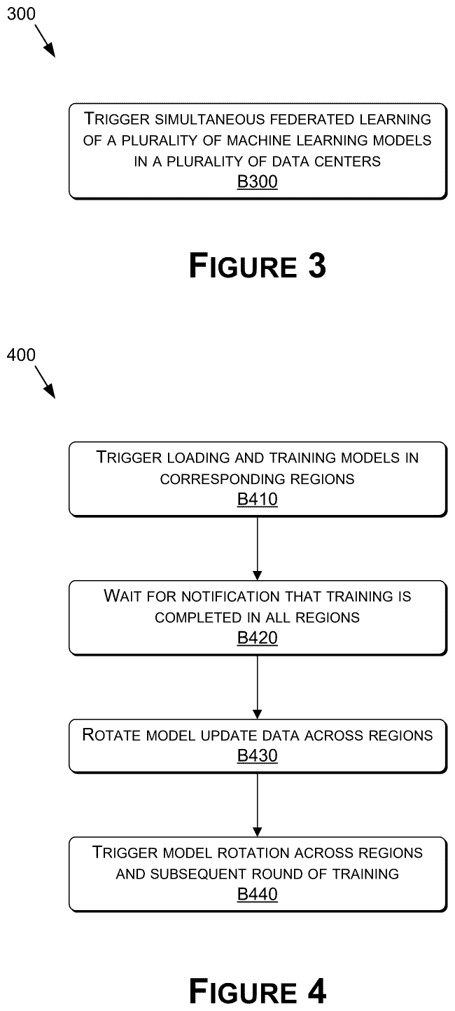

Now referring to FIG. 3, each block of method 300, described herein, comprises a computing process that may be performed using any combination of hardware, firmware, and/or software. For instance, various functions may be carried out by a processor executing instructions stored in memory. The method may be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 of triggering simultaneous federated learning, in accordance with some embodiments of the disclosure. The method 300, at block B300, includes triggering substantially simultaneous federated learning of a plurality of machine learning models in a plurality of data centers. For example, with respect to the example federated learning environment 100 of FIG. 1, the concurrent training scheduler 120 may trigger any number of machine learning models to begin training at any number of data centers at least partially simultaneously or with at least some amount of overlap in time. The concurrent training scheduler 120 may use data such as the processing speeds and capacities of the various data centers and/or data such as the topologies and number of steps per round of training of the various machine learning models when triggering simultaneous learning across the plurality of data centers.

Additionally or alternatively, upon completion of a first round of training, the method 300 may comprise triggering a second round of substantially simultaneous federated learning of the plurality of machine learning models in a plurality of data centers. For example, the second round may comprise triggering the transmission of model update data from the first round of training to each subsequent data center, and/or a second round of substantially simultaneous or least partially overlapping federated learning of the plurality of machine learning models in the plurality of data centers. In embodiments, this may comprise triggering the unloading of the current machine learning model at each data center and triggering the loading of the next machine learning model at each data center. The next machine learning model may then be trained using the training data stored at each next data center, such as the training data stored in training databases 144A-144D, and the model update data transmitted from the previous data center at which the machine learning models were trained to the next data center at which they are to be trained. This simultaneous federated learning may be triggered any number of times throughout the training process allowing for any number of machine learning models to be trained on training data across any number of data centers.

Now referring to FIG. 4, each block of method 400, described herein, comprises a computing process that may be performed using any combination of hardware, firmware, and/or software. For instance, various functions may be carried out by a processor executing instructions stored in memory. The method may be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1. However, this method may additionally or alternatively be executed by any one system, or any combination of systems, including, but not limited to, those described herein.

FIG. 4 is a flow diagram showing a method 400 of rotating model update data across regions, in accordance with some embodiments of the present disclosure. The method 400, at block B410, includes triggering loading and training of machine learning models in corresponding regions. As discussed above, any number of machine learning models may be trained across any number of regions. At block 420, the method comprises waiting for notification that training is completed in all regions. Said notification may be transmitted by local training orchestrators to a concurrent training scheduler. This may allow for the coordination of the rotation of machine learning models, model update date, and the triggering of the second round of training. At block 430, the method comprises rotating model update data across regions. The rotating of model update data may comprise transmitting model update data such as weights and gradients. The rotation of model update data may not comprise the transmission of geographically restricted training data. And, at block 440, the method comprises triggering model rotation across regions and a subsequent round of training. This method may be completed any number of times, for example, until the machine learning models have complete a predetermined number of rounds of training. Additionally or alternatively, this method may be continued for a predetermined amount of time.

The systems and methods described herein may be used to train models for or otherwise support a variety of techniques, by way of example and without limitation, for machine control, machine locomotion, machine driving, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:

Clause 1. One or more processors comprising processing circuitry to orchestrate substantially simultaneous federated learning of a plurality of different machine learning models in a plurality of data centers.

Clause 2. The one or more processors of clause 1, wherein the processing circuitry is further to orchestrate a first round of the substantially simultaneous federated learning based at least on triggering substantially simultaneous training of the plurality of different machine learning models in the plurality of data centers.

Clause 3. The one or more processors of clause 1, wherein the processing circuitry is further to orchestrate the substantially simultaneous federated learning based at least on triggering a rotation of the plurality of different machine learning models in the plurality of data centers without releasing or reallocating processing resources, of the plurality of data centers, allocated for the substantially simultaneous federated learning.

Clause 4. The one or more processors of clause 1, wherein the processing circuitry is further to trigger, based at least on receiving a notification of completion of a first round of training of a first of the plurality of different machine learning models within a first data center of the plurality of data centers, loading a second of the plurality of different machine learning models in the first data center.

Clause 5. The one or more processors of clause 1, wherein the processing circuitry is further to trigger a subsequent round of the substantially simultaneous federated learning based at least on receiving a notification of completion of a preceding round from at least one of the plurality of data centers.

Clause 6. The one or more processors of clause 1, wherein the processing circuitry is further to distribute model update data generated in each of the plurality of data centers during a first round of the substantially simultaneous federated learning to a corresponding subsequent one of the plurality of data centers in a rotation associated with the substantially simultaneous federated learning.

Clause 7. The one or more processors of clause 1, wherein the processing circuitry is further to trigger at least one of the plurality of data centers to load, train, and unload successive machine learning models of the plurality of different machine learning models in successive rounds of the substantially simultaneous federated learning.

Clause 8. The one or more processors of clause 1, wherein the one or more processors are comprised in at least one of: a system for performing one or more deep learning operations; a system implemented using an edge device; a system for generating synthetic data; a system for generating synthetic data using AI; a system for performing one or more simulation operations; a system for performing one or more remote operations; a system for performing real-time streaming; a system for training one or more language models; a system for training one or more large language models (LLMs); a system incorporating one or more virtual machines (VMs); a system implemented at least partially in a data center; or a system implemented at least partially using cloud computing resources.

Clause 9. A method comprising triggering at least partially overlapping federated learning of a plurality of machine learning models in a plurality of data centers.

Clause 10. The method of clause 9, wherein at least one processing resource at each of the plurality of data centers is used to update one or more parameters of each of the plurality of machine learning models.

Clause 11. The method of clause 9, wherein the triggering of the at least partially overlapping federated learning comprising triggering a first round of substantially simultaneous training of the plurality of machine learning models in the plurality of data centers.

Clause 12. The method of clause 9, wherein the triggering of the at least partially overlapping federated learning comprises orchestrating a rotation of the plurality of machine learning models in the plurality of data centers without releasing the at least one processing resource, of the plurality of data centers, allocated for the at least partially overlapping federated learning

Clause 13. The method of clause 9, further comprising triggering, based at least on receiving a notification of competition of a first round of training of a first of the plurality of machine learning models within a first data center of the plurality of data centers, loading a second of the plurality of machine learning models in the first data center.

Clause 14. The method of clause 9, further comprising triggering a subsequent round of the at least partially overlapping federated learning based at least on receiving a notification of completion of a preceding round from each of the plurality of data centers.

Clause 15. The method of claim 9, wherein the method is performed by at least one of: a system for performing one or more deep learning operations; a system implemented using an edge device; a system for generating synthetic data; a system for generating synthetic data using AI; a system for performing one or more simulation operations; a system for performing one or more remote operations; a system for performing real-time streaming; a system for training one or more language models; a system for training one or more large language models (LLMs); a system incorporating one or more virtual machines (VMs); a system implemented at least partially in a data center; or a system implemented at least partially using cloud computing resources.

Clause 16. A system comprising one or more processors to interleave concurrent federated learning of a plurality of different machine learning models between and among a plurality of data centers such that at least one processing resource at each data center performs at least a portion of the learning for each of the plurality of different machine learning models.

Clause 17. The system of clause 16, wherein the one or more processors are further to distribute model update data generated in each of the plurality of data centers during a first round of the concurrent federated learning to a corresponding subsequent one of the plurality of data centers in a rotation associated with the concurrent federated learning.

Clause 17. The system of clause 16, wherein the one or more processors are further to trigger at least one of the plurality of data centers to load, train, and unload successive machine learning models of the plurality of different machine learning models in successive rounds of the concurrent federated learning.

Clause 17. The system of clause 16, wherein the one or more processors are further to orchestrate a first round of the concurrent federated learning based at least on triggering substantially simultaneous training of the plurality of different machine learning models in the plurality of data centers.

Clause 17. The system of clause 16, wherein the one or more processors are further to orchestrate the concurrent federated learning based at least on triggering a rotation of the plurality of different machine learning models in the plurality of data centers without releasing the at least one processing resource, of the plurality of data centers, allocated for the concurrent federated learning.

Clause 17. The system of clause 16, wherein the system is comprised in at least one of: a system for performing one or more deep learning operations; a system implemented using an edge device; a system for generating synthetic data; a system for generating synthetic data using AI; a system for performing one or more simulation operations; a system for performing one or more remote operations; a system for performing real-time streaming; a system for training one or more language models; a system for training one or more large language models (LLMs); a system incorporating one or more virtual machines (VMs); a system implemented at least partially in a data center; or a system implemented at least partially using cloud computing resources.

What is claimed is:

1. One or more processors comprising processing circuitry to:
orchestrate substantially simultaneous federated learning of a plurality of different machine learning models in a plurality of data centers.

2. The one or more processors of claim 1, wherein the processing circuitry is further to orchestrate a first round of the substantially simultaneous federated learning based at least on triggering substantially simultaneous training of the plurality of different machine learning models in the plurality of data centers.

3. The one or more processors of claim 1, wherein the processing circuitry is further to orchestrate the substantially simultaneous federated learning based at least on triggering a rotation of the plurality of different machine learning models in the plurality of data centers without releasing or reallocating processing resources, of the plurality of data centers, allocated for the substantially simultaneous federated learning.

4. The one or more processors of claim 1, wherein the processing circuitry is further to trigger, based at least on receiving a notification of completion of a first round of training of a first of the plurality of different machine learning models within a first data center of the plurality of data centers, loading a second of the plurality of different machine learning models in the first data center.

5. The one or more processors of claim 1, wherein the processing circuitry is further to trigger a subsequent round of the substantially simultaneous federated learning based at least on receiving a notification of completion of a preceding round from at least one of the plurality of data centers.

6. The one or more processors of claim 1, wherein the processing circuitry is further to distribute model update data generated in each of the plurality of data centers during a first round of the substantially simultaneous federated learning to a corresponding subsequent one of the plurality of data centers in a rotation associated with the substantially simultaneous federated learning.

7. The one or more processors of claim 1, wherein the processing circuitry is further to trigger at least one of the plurality of data centers to load, train, and unload successive machine learning models of the plurality of different machine learning models in successive rounds of the substantially simultaneous federated learning.

8. The one or more processors of claim 1, wherein the one or more processors are comprised in at least one of:
a system for performing one or more deep learning operations;
a system implemented using an edge device;
a system for generating synthetic data;
a system for generating synthetic data using AI;
a system for performing one or more simulation operations;
a system for performing one or more remote operations;
a system for performing real-time streaming;
a system for training one or more language models;
a system for training one or more large language models (LLMs);
a system incorporating one or more virtual machines (VMs);
a system implemented at least partially in a data center; or
a system implemented at least partially using cloud computing resources.

9. A method comprising:
triggering at least partially overlapping federated learning of a plurality of machine learning models in a plurality of data centers, wherein at least one processing resource at each of the plurality of data centers is used to update one or more parameters of each of the plurality of machine learning models.

10. The method of claim 9, wherein the triggering of the at least partially overlapping federated learning comprising triggering a first round of substantially simultaneous training of the plurality of machine learning models in the plurality of data centers.

11. The method of claim 9, wherein the triggering of the at least partially overlapping federated learning comprises orchestrating a rotation of the plurality of machine learning models in the plurality of data centers without releasing the at least one processing resource, of the plurality of data centers, allocated for the at least partially overlapping federated learning.

12. The method of claim 9, further comprising triggering, based at least on receiving a notification of competition of a first round of training of a first of the plurality of machine learning models within a first data center of the plurality of data centers, loading a second of the plurality of machine learning models in the first data center.

13. The method of claim 9, further comprising triggering a subsequent round of the at least partially overlapping federated learning based at least on receiving a notification of completion of a preceding round from each of the plurality of data centers.

14. The method of claim 9, wherein the method is performed by at least one of:
a system for performing one or more deep learning operations;
a system implemented using an edge device;
a system for generating synthetic data;
a system for generating synthetic data using AI;
a system for performing one or more simulation operations;
a system for performing one or more remote operations;
a system for performing real-time streaming;
a system for training one or more language models;
a system for training one or more large language models (LLMs);
a system incorporating one or more virtual machines (VMs);
a system implemented at least partially in a data center; or
a system implemented at least partially using cloud computing resources.

15. A system comprising one or more processors to interleave concurrent federated learning of a plurality of different machine learning models between and among a plurality of data centers such that at least one processing resource at each data center performs at least a portion of the learning for each of the plurality of different machine learning models.

16. The system of claim 15, wherein the one or more processors are further to distribute model update data generated in each of the plurality of data centers during a first round of the concurrent federated learning to a corresponding subsequent one of the plurality of data centers in a rotation associated with the concurrent federated learning.

17. The system of claim 15, wherein the one or more processors are further to trigger at least one of the plurality of data centers to load, train, and unload successive machine learning models of the plurality of different machine learning models in successive rounds of the concurrent federated learning.

18. The system of claim 15, wherein the one or more processors are further to orchestrate a first round of the concurrent federated learning based at least on triggering substantially simultaneous training of the plurality of different machine learning models in the plurality of data centers.

19. The system of claim 15, wherein the one or more processors are further to orchestrate the concurrent federated learning based at least on triggering a rotation of the plurality of different machine learning models in the plurality of data centers without releasing the at least one processing resource, of the plurality of data centers, allocated for the concurrent federated learning.

20. The system of claim 15, wherein the system is comprised in at least one of:
a system for performing one or more deep learning operations;
a system implemented using an edge device;
a system for generating synthetic data;
a system for generating synthetic data using AI;
a system for performing one or more simulation operations;
a system for performing one or more remote operations;
a system for performing real-time streaming;
a system for training one or more language models;
a system for training one or more large language models (LLMs);
a system incorporating one or more virtual machines (VMs);
a system implemented at least partially in a data center; or
a system implemented at least partially using cloud computing resources.
